(19) United States
(12) Patent Application Publication
(10) Pub. No.: US 2017/0277369 A1
(43) Pub. Date: Sep. 28, 2017

(54) METHOD AND DEVICE FOR STARTING AN APPLICATION APP

(71) Applicants: Le Holdings(Beijing)Co., Ltd., Beijing (CN); LE SHI ZHI XIN ELECTRONIC TECHNOLOGY (TIAN JIN) LIMITED, Tianjin (CN)

(72) Inventors: Xianhao Zhao, Tianjin (CN); Donghan Wen, Tianjin (CN)

(21) Appl. No.: 15/247,763

(22) Filed: Aug. 25, 2016

Related U.S. Application Data
(63) Continuation of application No. PCT/CN2016/088982, filed on Jul. 6, 2016.

(30) Foreign Application Priority Data
Mar. 25, 2016 (CN) 201610180301.6

(51) Int. Cl. G06F 3/0482; H04L 29/06; H04W 48/16

(52) U.S. Cl. CPC G06F 3/0482; H04W 48/16; H04L 63/105

(57) ABSTRACT

Embodiments of the disclosure provide a method and device for starting an application APP so as to address the problem of troublesome starting of the APP in a secured network environment. The method for starting an application APP includes: upon determining that a currently accessed network is a secured network, displaying, by a terminal, on a display screen of the terminal a button to start a verification-exempt function corresponding to at least one APP installed on the terminal, and setting the displayed button to start the verification-exempt function to an optional state; and if it is detected that one of the APPs is selected and the button to start the verification-exempt function corresponding to the selected APP is selected, then opening directly an interface of the selected APP.

### CROSS-REFERENCE TO RELATED APPLICATIONS

This application is a continuation of International Application No. PCT/CN2016/088982, filed on Jul. 6, 2016, which is based upon and claims priority to Chinese Patent Application No. 201610180301.6, filed on Mar. 25, 2016, the entire contents of which are incorporated herein by reference.

### TECHNICAL FIELD

The present disclosure relates to the field of computer technologies, and particularly to a method and device for starting an application APP.

### BACKGROUD

At present, an application management center of an intelligent terminal typically displays or exhibits applications on a display screen of the intelligent terminal in the form of icons or graphs.

The inventors have identified during making of the invention at least the following problems in the related technologies: for the majority of intelligent terminals, if their users need to start some APP, then they will firstly unlock the terminals, and then locate and click on the icon of the APP to be opened, enter a verification interface of the APP, and enter an interface of the APP only after verification information is correct. Moreover these operations have to be repeated each time the APP is desired to be opened, which may apparently be time-consuming for the user, thus degrading an experience of the user for the product.

### SUMMARY

Embodiments of the disclosure provide a method and device for starting an application APP so as to address the problem in the prior art of troublesome starting of the APP in a secured network environment.

In an aspect, embodiments of the disclosure provides a method for starting an APP, the method including: upon determining that a currently accessed network is a secured network, displaying, by an electronic device, on a display screen of the electronic device a button to start a verification-exempt function corresponding to at least one APP installed on the electronic device, and setting the displayed button to start the verification-exempt function to an optional state; and if it is detected that one of the APPs is selected and the button to start the verification-exempt function corresponding to the selected APP is selected, then opening, by the electronic device, directly an interface of the selected APP.

In another aspect, embodiments of the disclosure provides an electronic device, including: at least one processor; and a memory communicably connected with the at least one processor for storing instructions executable by the at least one processor, wherein execution of the instructions by the at least one processor causes the at least one processor to: determine that a currently accessed network is a secured network; display on a display screen of the electronic device a button to start a verification-exempt function corresponding to at least one APP installed on the electronic device, and set the displayed button to start the verification-exempt function to an optional state; and if it is detected that one of the APPs is selected and the button to start the verification-exempt function corresponding to the selected APP is selected, open directly an interface of the selected APP.

In further aspect, embodiments of the disclosure provides a non-transitory computer-readable storage medium storing executable instructions that, when executed by an electronic device, cause the electronic device to: determine that a currently accessed network is a secured network; display on a display screen of the electronic device a button to start a verification-exempt function corresponding to at least one APP installed on the electronic device, and set the displayed button to start the verification-exempt function to an optional state; and if it is detected that one of the APPs is selected and the button to start the verification-exempt function corresponding to the selected APP is selected, open directly an interface of the selected APP.

With the method and device for starting an APP according to the embodiments of the disclosure, the button to start the verification-exempt function corresponding to the APP is selected upon determining that the currently accessed network is a secured network, so that if the APP corresponding to the selected button to start the verification-exempt function is selected, then the APP will be opened directly without verifying the APP to thereby avoid the APP from being verified in the secured network so as to simplify the operations of opening the APP, thus speeding up opening of the APP.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for starting an application APP in accordance with some embodiments;

FIG. 2a to FIG. 2d are schematic diagrams of a displayed button to start a verification-exempt function respectively accordance with some embodiments;

FIG. 3 is a schematic structural diagram of a device for starting an application APP in accordance with some embodiments; and

FIG. 4 is a schematic diagram of an electronic device for starting an application APP in accordance with some embodiments.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

Embodiments of the disclosure will be described below with reference to the drawings.

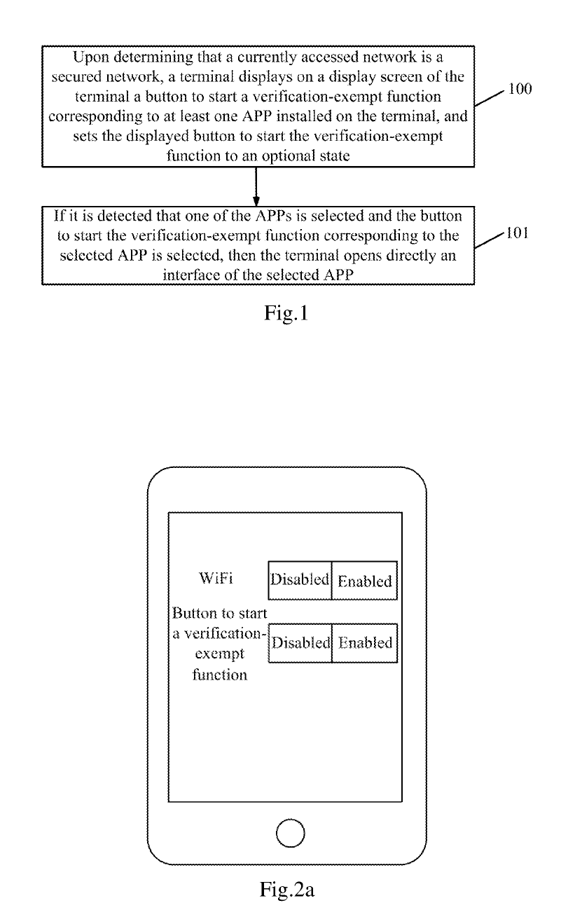

As illustrated in FIG. 1, a method for starting an application APP according to an embodiment of the disclosure includes:

In the operation 100, upon determining that a currently accessed network is a secured network, a terminal displays on a display screen of the terminal a button to start a verification-exempt function corresponding to at least one APP installed on the terminal, and sets the displayed button to start the verification-exempt function to an optional state; and

In the operation 101, if it is detected that one of the APPs is selected and the button to start the verification-exempt function corresponding to the selected APP is selected, then the terminal opens directly an interface of the selected APP.

It shall be noted that the terminal according to the embodiment of the disclosure can be a smart handset, a tablet computer, a notebook computer, or another display device which can access the network; and the network according to the embodiment of the disclosure can be one of but will not be limited to a Wireless-Fidelity (WiFi) network, a Wireless Local Area Network (WLAN), etc.

The following description will be given taking a WiFi network as an example, but the same will apply to another network, so a repeated description thereof will be omitted here.

It shall be noted that the terminal can display the button to start the verification-exempt function corresponding to the APP, on an interface which is newly popped up, or can display the button to start the verification-exempt function corresponding to the APP, on an interface to enable the WiFi network.

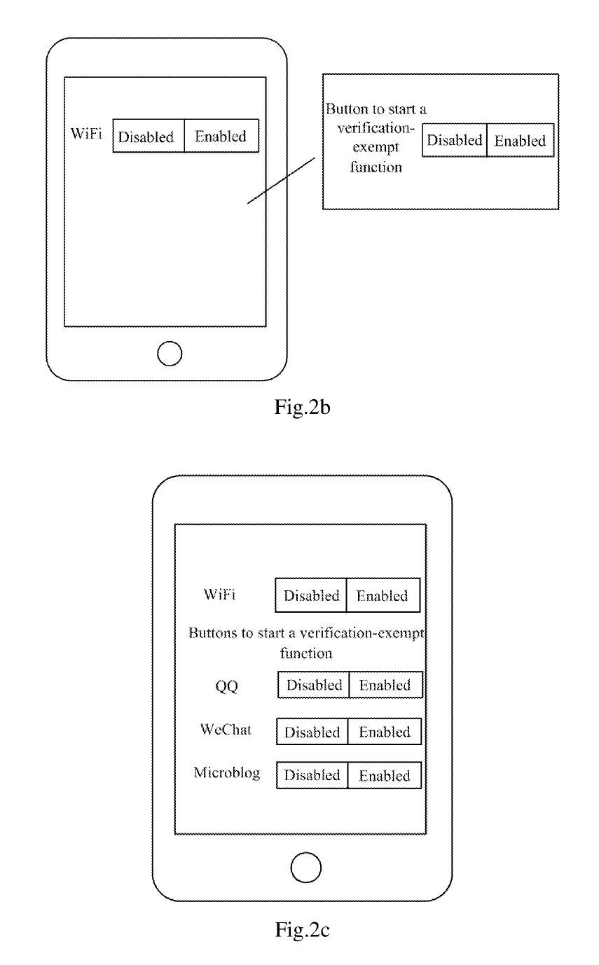

FIG. 2a illustrates an example in which all the APPs installed on the terminal correspond to the same button to start the verification-exempt function, which is displayed in the same interface as a WiFi switch, where if the terminal detects that the currently accessed WiFi network is a secured network, then the button to start the verification-exempt function may be displayed at a preset position in the same interface as the WiFi switch, and the verification-exempt function may be set to an optional state. If the terminal detects that the currently accessed WiFi network is not a secured network, then the button to start the verification-exempt function may also be displayed at the preset position in the same interface as the WiFi switch, but the verification-exempt function may be set to a non-optional state, that is, the user cannot operate on the button to start the verification-exempt function, or if the terminal detects that the currently accessed WiFi network is not a secured network, then the button to start the verification-exempt function may not be displayed at the preset position in the same interface as the WiFi switch.

FIG. 2b illustrates an example in which if all the APPs installed on the terminal correspond to the same button to start the verification-exempt function, then the terminal may pop up a new display interface upon detecting that the current WiFi network is a secured network, where the new display interface includes the button to start the verification-exempt function in the optional state.

However in order to enable the user to select corresponding one or more of the APPs installed on the terminal to be verification-exempt, preferably the respective APPs installed on the terminal correspond to respective buttons to start the verification-exempt function; or the respective categories of APPs installed on the terminal correspond to respective buttons to start the verification-exempt function; or at least one button to start the verification-exempt function can be arranged as required for the user so that each button to start the verification-exempt function corresponds to one of the APPs required for the user to be verification-exempt in the secured network.

For example, the APPs installed on the terminal include QQ, Microblog, and WeChat, each of which corresponds to one of the buttons to start the verification-exempt function, which are exhibited particularly as illustrated in FIG. 2c and FIG. 2d.

Here if the terminal detects that the terminal is switched from the currently accessed WiFi network to a new WiFi network, then the terminal may set the displayed buttons to start the verification-exempt function to a non-optional state upon determining that the new WiFi network is not a secured network.

It shall be noted that if the button to start the verification-exempt function is displayed in the same interface as the WiFi switch, or in the same interface as another function button in the terminal, then the button to start the verification-exempt function may be displayed regardless of whether the currently accessed WiFi network is a secured network, but if the currently accessed WiFi network is a secured network, then the button to start the verification-exempt function may be set to the optional state, and the user can operate thereon; and if it is detected that the accessed network is not a secured network, then the button to start the verification-exempt function may be set to the non-optional state so that the user cannot operate thereon, thus avoiding an unnecessary loss arising from information being revealed because the button to start the verification-exempt function is started due to an improper operation by the user if the terminal is switched to a new WiFi network which is not a secured network.

The terminal pops up a new display interface upon detecting that the currently accessed WiFi network is a secured network, where the button to start the verification-exempt function is displayed on the display interface, and the terminal does not pop up any display interface on which the button to start the verification-exempt function is displayed, upon detecting that the currently accessed WiFi network is not a secured network.

In an embodiment of the disclosure, the terminal can determine whether the currently accessed WiFi network is a secured network as follows, but the embodiment of the disclosure will not be limited thereto, and any other scheme to determine whether the currently accessed

WiFi network is a secured network shall fall into the scope of the disclosure as claimed.

In a scheme, the terminal determines that the currently accessed WiFi network is a secured network, upon determining that the security level of the currently accessed WiFi network exceeds a preset security level.

For example, a security attribute of the network, e.g., WiFi Enabled is set among device network security attribute information in the terminal accessing the network, and if a WiFi network is accessed for the first time, then an indicator of the category of the security level of the network may be popped up, and if the user determines that the network environment is secured, then the security level which is set for the WiFi network may be high, so that the terminal determines that the WiFi network is a secured network if the security level exceeds a preset level.

Here the terminal can store the identifier of the WiFi network in its list of identifies of secured networks, and determine that the currently accessed WiFi network is a secured network upon determining that the identifier of the currently accessed WiFi network is stored in its stored list of identifiers of secured networks while accessing the WiFi network again.

Alternatively the terminal can preset and store identifiers of some WiFi networks in its stored list of identifiers of secured networks, and determine that the currently accessed WiFi network is a secured network upon determining that the identifier of the currently accessed WiFi network is stored in its stored list of identifiers of secured networks.

Based upon the same inventive idea, an embodiment of the disclosure further provides a terminal for starting an application APP, and since a method corresponding to the terminal for starting an application APP is the method for starting an application APP according to the embodiment of the disclosure, reference can be made for an implementation of the method for an implementation of the terminal for starting an application APP according to the embodiment of the disclosure, so a repeated description thereof will be omitted here.

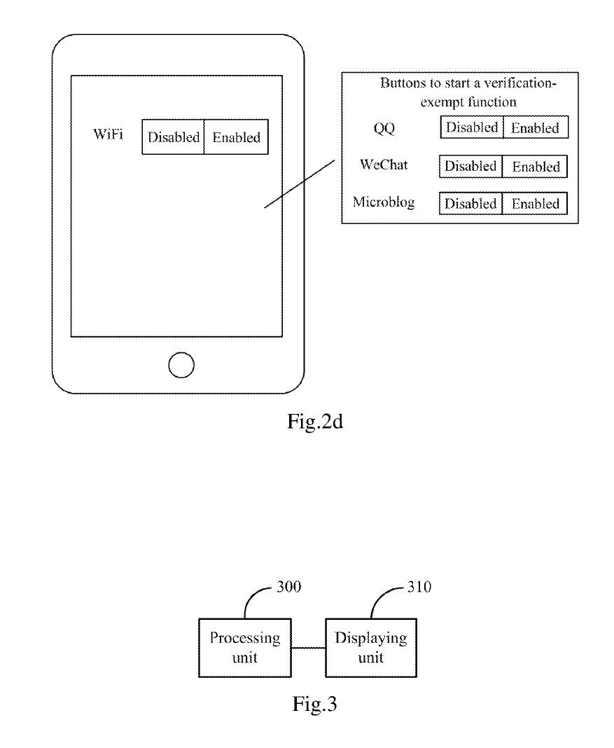

As illustrated in FIG. 3, the terminal for starting an application APP according to the embodiment of the disclosure includes a processing unit 300 and a displaying unit 310, where the processing unit 300 is configured to determine that a currently accessed network is a secured network; the displaying unit 310 is configured to display on a display screen of the terminal a button to start a verification-exempt function corresponding to at least one APP installed on the terminal, and to set the displayed button to start the verification-exempt function to an optional state; and the processing unit 300 is further configured, if it is detected that one of the APPs is selected and the button to start the verification-exempt function corresponding to the selected APP is selected, to open directly an interface of the selected APP.

Optionally the processing unit 300 is further configured, if it is detected that the terminal is switched from the currently accessed network to a new WiFi network, to set the displayed button to start the verification-exempt function to a non-optional state upon determining that the new network is not a secured network.

Optionally the processing unit 300 is configured to determine that the currently accessed network is a secured network, upon determining that a security level of the currently accessed network exceeds a preset security level.

Optionally the processing unit 300 is configured to determine that the currently accessed network is a secured network, upon determining that an identifier of the currently accessed network is stored in a list of identifiers of secured networks stored in the terminal.

Optionally the respective APPs installed on the terminal correspond to the respective buttons to start the verification-exempt function; or all the APPs installed on the terminal correspond to the same button to start the verification-exempt function.

It shall be noted that the terminal has been schematically divided into the logically functional units in the embodiments of the disclosure, but the terminal can be divided otherwise in a real implementation. Moreover the respective functions in the respective embodiments of the disclosure can be integrated in the same processing unit, or can physically exist separately, or two or more of the units can be integrated in the same unit. The integrated units can be embodied in hardware, or can be embodied as software functional units.

Here if the units of the terminal in the embodiments of the disclosure are embodied in hardware, then the processing unit 300 can be embodied by a processor of the terminal, and the display unit 310 can be embodied by a display device of the terminal.

As can be apparent from the disclosure, upon determining that the currently accessed network is a secured network, the terminal displays on the display screen of the terminal the button to start the verification-exempt function corresponding to at least one APP installed on the terminal, and sets the displayed button to start the verification-exempt function to an optional state; and if it is detected that one of the APPs is selected and the button to start the verification-exempt function corresponding to the selected APP is selected, then the terminal will open directly the interface of the selected APP. With this technical solution, the button to start the verification-exempt function corresponding to the APP is selected upon determining that the currently accessed network is a secured network, so that if the APP corresponding to the selected button to start the verification-exempt function is selected, then the APP will be opened directly without verifying the APP to thereby avoid the APP from being verified in the secured network so as to simplify the operations of opening the APP, thus speeding up opening of the APP.

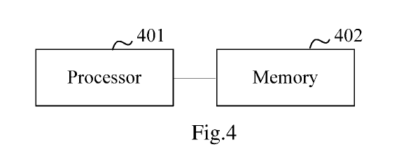

Based upon the same inventive idea, an embodiment of the disclosure further provides an electronic device for starting an application APP, as illustrated in FIG. 4, which includes:

At least one processor 401 and a memory 402, where there is one processor as an example in FIG. 4.

The memory 402 is communicably connected with the at least one processor for storing instructions executable by the at least one processor, wherein execution of the instructions by the at least one processor causes the at least one processor to:

Determine that a currently accessed network is a secured network;

Display on a display screen of the electronic device a button to start a verification-exempt function corresponding to at least one APP installed on the electronic device, and set the displayed button to start the verification-exempt function to an optional state; and

If it is detected that one of the APPs is selected and the button to start the verification-exempt function corresponding to the selected APP is selected, open directly an interface of the selected APP.

In one embodiment, the execution of the instructions by the at least one processor further causes the at least one processor to:

If it is detected that the electronic device is switched from the currently accessed network to a new network, set the displayed button to start the verification-exempt function to a non-optional state upon determining that the new network is not a secured network.

In one embodiment, the execution of the instructions by the at least one processor further causes the at least one processor to:

Determine that the currently accessed network is a secured network, upon determining that a security level of the currently accessed network exceeds a preset security level.

In one embodiment, the execution of the instructions by the at least one processor further causes the at least one processor to:

Determine that the currently accessed network is a secured network, upon determining that an identifier of the currently accessed network is stored in a list of identifiers of secured networks stored in the electronic device.

In one embodiment, the button to start the verification-exempt function corresponding to the at least one APP installed on the electronic device includes:

The respective buttons to start the verification-exempt function corresponding to the respective APPs installed on the electronic device; or

The same button to start the verification-exempt function corresponding to all the APPs installed on the electronic device.

Based upon the same inventive idea, an embodiment of the disclosure further provides a non-transitory computer-readable storage medium storing executable instructions that, when executed by an electronic device, cause the electronic device to:

Determine that a currently accessed network is a secured network;

Display on a display screen of the electronic device a button to start a verification-exempt function corresponding to at least one APP installed on the electronic device, and set the displayed button to start the verification-exempt function to an optional state; and

If it is detected that one of the APPs is selected and the button to start the verification-exempt function corresponding to the selected APP is selected, open directly an interface of the selected APP.

In one embodiment, the executable instructions executed by the electronic device further cause the electronic device to:

If it is detected that the electronic device is switched from the currently accessed network to a new network, set the displayed button to start the verification-exempt function to a non-optional state upon determining that the new network is not a secured network.

In one embodiment, the executable instructions executed by the electronic device further cause the electronic device to:

Determine that the currently accessed network is a secured network, upon determining that a security level of the currently accessed network exceeds a preset security level.

In one embodiment, the executable instructions executed by the electronic device further cause the electronic device to:

Determine that the currently accessed network is a secured network, upon determining that an identifier of the currently accessed network is stored in a list of identifiers of secured networks stored in the electronic device.

In one embodiment, the button to start the verification-exempt function corresponding to the at least one APP installed on the electronic device includes:

The respective buttons to start the verification-exempt function corresponding to the respective APPs installed on the electronic device; or

The same button to start the verification-exempt function corresponding to all the APPs installed on the electronic device.

The aforementioned electronic device can execute the method according to some embodiments of the disclosure, and has functional modules for executing corresponding method and advantageous thereof. For more technical details, the method according to some embodiments of the disclosure can be referred.

The electronic device according to some embodiments of the disclosure can be in multiple forms, which include but not limit to:

1. Mobile communication device, of which characteristic has mobile communication function, and briefly acts to provide voice and data communication. These terminals include smart pone (i.e. iPhone), multimedia mobile phone, feature phone, cheap phone and etc.

2. Ultra mobile personal computing device, which belongs to personal computer, and has function of calculation and process, and has mobile networking function in general. These terminals include PDA, MID, UMPC (Ultra Mobile Personal Computer) and etc.

3. Portable entertainment equipment, which can display and play multimedia contents. These equipments include audio player, video player (e.g. iPod), handheld game player, electronic book, hobby robot and portable vehicle navigation device.

4. Server, which provides computing services, and includes processor, hard disk, memory, system bus and etc. The framework of the server is similar to the framework of universal computer, however, there is a higher requirement for processing capacity, stability, reliability, safety, expandability, manageability and etc due to supply of high reliability services.

5. Other electronic devices having data interaction function.

Those ordinarily skilled in the art can appreciate that all or a part of the operations in the methods according to the embodiments described above can be performed by program instructing relevant hardware, where the programs can be stored in a computer readable storage medium, and the programs can perform one or a combination of the operations in the embodiments of the method upon being executed; and the storage medium includes an ROM, an RAM, a magnetic disc, an optical disk, or any other medium which can store program codes.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A method for starting an application APP, the method comprising:
upon determining that a currently accessed network is a secured network, displaying, by an electronic device, on a display screen of the electronic device a button to start a verification-exempt function corresponding to at least one APP installed on the electronic device, and setting the displayed button to start the verification-exempt function to an optional state; and
if it is detected that one of the APPs is selected and the button to start the verification-exempt function corresponding to the selected APP is selected, then opening, by the electronic device, directly an interface of the selected APP.

2. The method according to claim 1, further comprising:
if it is detected that the electronic device is switched from the currently accessed network to a new network, then setting, by the electronic device, the displayed button to start the verification-exempt function to a non-optional state upon determining that the new network is not a secured network.

3. The method according to claim 1, wherein determining, by the electronic device, that the currently accessed network is a secured network comprises:
determining, by the electronic device, that the currently accessed network is a secured network, upon determining that a security level of the currently accessed network exceeds a preset security level.

4. The method according to claim 2, wherein determining, by the electronic device, that the currently accessed network is a secured network comprises:
determining, by the electronic device, that the currently accessed network is a secured network, upon determining that a security level of the currently accessed network exceeds a preset security level.

5. The method according to claim 1, wherein determining, by the electronic device, that the currently accessed network is a secured network comprises:
determining, by the electronic device, that the currently accessed network is a secured network, upon determining that an identifier of the currently accessed network is stored in a list of identifiers of secured networks stored in the electronic device.

6. The method according to claim 2, wherein determining, by the electronic device, that the currently accessed network is a secured network comprises:
determining, by the electronic device, that the currently accessed network is a secured network, upon determining that an identifier of the currently accessed network is stored in a list of identifiers of secured networks stored in the electronic device.

7. The method according to claim 1, wherein the button to start the verification-exempt function corresponding to the at least one APP installed on the electronic device comprises:
the respective buttons to start the verification-exempt function corresponding to the respective APPs installed on the electronic device; or
the same button to start the verification-exempt function corresponding to all the APPs installed on the electronic device.

8. An electronic device, comprising:
at least one processor; and
a memory communicably connected with the at least one processor for storing instructions executable by the at least one processor, wherein execution of the instructions by the at least one processor causes the at least one processor to:
determine that a currently accessed network is a secured network;
display on a display screen of the electronic device a button to start a verification-exempt function corresponding to at least one APP installed on the electronic device, and set the displayed button to start the verification-exempt function to an optional state; and
if it is detected that one of the APPs is selected and the button to start the verification-exempt function corresponding to the selected APP is selected, open directly an interface of the selected APP.

9. The electronic device according to claim 8, wherein the execution of the instructions by the at least one processor further causes the at least one processor to:
if it is detected that the electronic device is switched from the currently accessed network to a new network, set the displayed button to start the verification-exempt function to a non-optional state upon determining that the new network is not a secured network.

10. The electronic device according to claim 8, wherein the execution of the instructions by the at least one processor further causes the at least one processor to:
determine that the currently accessed network is a secured network, upon determining that a security level of the currently accessed network exceeds a preset security level.

11. The electronic device according to claim 9, wherein the execution of the instructions by the at least one processor further causes the at least one processor to:
determine that the currently accessed network is a secured network, upon determining that a security level of the currently accessed network exceeds a preset security level.

12. The electronic device according to claim 8, wherein the execution of the instructions by the at least one processor further causes the at least one processor to:
determine that the currently accessed network is a secured network, upon determining that an identifier of the currently accessed network is stored in a list of identifiers of secured networks stored in the electronic device.

13. The electronic device according to claim 9, wherein the execution of the instructions by the at least one processor further causes the at least one processor to:
determine that the currently accessed network is a secured network, upon determining that an identifier of the currently accessed network is stored in a list of identifiers of secured networks stored in the electronic device.

14. The electronic device according to claim 8, wherein the button to start the verification-exempt function corresponding to the at least one APP installed on the electronic device comprises:
the respective buttons to start the verification-exempt function corresponding to the respective APPs installed on the electronic device; or
the same button to start the verification-exempt function corresponding to all the APPs installed on the electronic device.

15. A non-transitory computer-readable storage medium storing executable instructions that, when executed by an electronic device, cause the electronic device to:
determine that a currently accessed network is a secured network;
display on a display screen of the electronic device a button to start a verification-exempt function corresponding to at least one APP installed on the electronic device, and set the displayed button to start the verification-exempt function to an optional state; and
if it is detected that one of the APPs is selected and the button to start the verification-exempt function corresponding to the selected APP is selected, open directly an interface of the selected APP.

16. The non-transitory computer-readable storage medium according to claim 15, wherein the executable instructions executed by the electronic device further cause the electronic device to:
if it is detected that the electronic device is switched from the currently accessed network to a new network, set the displayed button to start the verification-exempt function to a non-optional state upon determining that the new network is not a secured network.

17. The non-transitory computer-readable storage medium according to claim 15, wherein the executable instructions executed by the electronic device further cause the electronic device to:
determine that the currently accessed network is a secured network, upon determining that a security level of the currently accessed network exceeds a preset security level.

18. The non-transitory computer-readable storage medium according to claim 16, wherein the executable instructions executed by the electronic device further cause the electronic device to:
determine that the currently accessed network is a secured network, upon determining that a security level of the currently accessed network exceeds a preset security level.

19. The non-transitory computer-readable storage medium according to claim 15, wherein the executable instructions executed by the electronic device further cause the electronic device to:
determine that the currently accessed network is a secured network, upon determining that an identifier of the currently accessed network is stored in a list of identifiers of secured networks stored in the electronic device.

20. The on-transitory computer-readable storage medium according to claim 15, wherein the button to start the verification-exempt function corresponding to the at least one APP installed on the electronic device comprises:
the respective buttons to start the verification-exempt function corresponding to the respective APPs installed on the electronic device; or
the same button to start the verification-exempt function corresponding to all the APPs installed on the electronic device.
